(19) United States
(12) Patent Application Publication
(10) Pub. No.: US 2007/0141940 A1
(43) Pub. Date: Jun. 21, 2007

(54) Lightweight, breathable, waterproof, soft shell composite apparel and technical alpine apparel

(76) Inventor: Baychar, Kingfield, ME (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/584,628

(22) Filed: Oct. 23, 2006

Related U.S. Application Data
(60) Provisional application No. 60/714,535, filed on Oct. 28, 2005.

(51) Int. Cl. B32B 5/24; B32B 5/26; B32B 15/14; B32B 5/18

(52) U.S. Cl. 442/328; 442/334; 442/370; 442/381; 442/337; 442/376; 442/414

(57) ABSTRACT

The apparel is constructed from various combinations of layers of materials with moisture transfer properties. A first liner of moisture transfer fabrics abuts a second layer of structural material such as open-cell foam. The second layer can abut a breathable membrane and/or an insulating material. Finally, carefully selected outer fabric completes the combination to provide apparel with improved performance characteristics. The outer fabrics are treated in various ways to enhance performance.

### CROSS-REFERENCE TO RELATED APPLICATIONS

This application claims priority from U.S. Provisional Application 60/714,535, filed Oct. 28, 2005.

### FIELD OF THE INVENTION

The present invention relates to apparel (garments) which are particularly suited to transfer moisture away from an individual. Particularly, the present invention relates to apparel constructed according to a moisture transfer system having a combination of breathable layers that removes moisture away from an individual while also being comfortable and aesthetically pleasing in appearance.

### BACKGROUND OF THE INVENTION

Various types of apparel are known in the prior art. However, none of these provides the advantages provided by the present invention. In particular, the types of apparel known in the prior art do not take advantage of the new advances in materials and fabrics that have been made in recent years. Additionally, new apparel known in the prior art does not teach a moisture transfer system based upon specific combinations of layers as taught in the present invention.

### SUMMARY OF THE INVENTION

The present inventor has recognized the deficiencies in the apparel known in the prior art and has designed new apparel that is capable of overcoming those deficiencies. More specifically, the present invention discloses a carefully selected combination of specific fibers, fabrics and material layers that enable moisture transfer, while at the same time providing comfort to the individual wearing the apparel.

An object of the present invention is to provide apparel that can quickly transfer moisture away from an individual's body so that the individual can feel more comfortable.

Another object of the present invention is to provide individuals involved in alpine and outdoor activities such as in-line skating, snowboarding, skiing, hiking, climbing, biking, playing golf and tennis etc., with active wear with increased performance and functional to deal with the additional moisture that is generated by such individuals while involved in such activities.

Yet another object of the present invention is to provide a combination of nonwoven and foam-like materials and fabrics-like materials resulting from the latest technological advances in a manner unknown in the prior art.

These and other objects, features, and advantages of the present invention will become more apparent in view of the following detailed description of the preferred embodiments in conjunction with the drawings.

### BRIEF DESCRIPTION OF THE DRAWINGS

FIG. 1 generally illustrates the layers forming the combination according to an embodiment of the present invention.

FIGS. 2-6 illustrate various applications of the different combinations of materials utilized according to the present invention.

### DETAILED DESCRIPTION OF THE PREFERRED EMBODIMENTS

A detailed description of the preferred embodiments will now be included in conjunction with the Figures. It should be understood that these embodiments are set forth for purposes of explanation only and are not to be interpreted as the only application of the present invention.

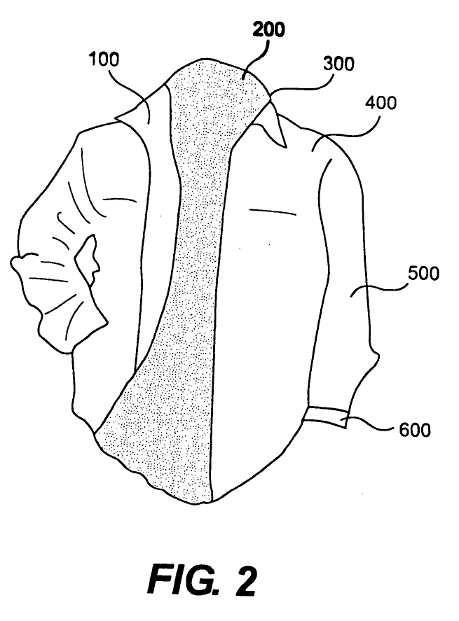

The apparel illustrated in FIGS. 2-6 includes shirts and jackets. Although not specifically illustrated, all of the types of apparel can be manufactured according to the present invention. The application of this invention to other types of apparel could easily be accomplished by one with ordinary skill in the art.

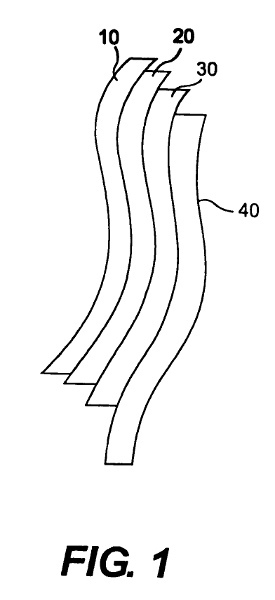

FIG. 1 generally illustrates the composite layers that are a result of a preferred embodiment of the present invention, namely a first (inner) layer 10, a second layer 20, a third layer 30, and a fourth (outer) layer 40. On some preferable options one or more layers are eliminated. These layers are attached to each other either by an environmentally friendly adhesive, mechanical bonding (or stitch bonding, such as that performed by Tietex, Inc., or Xymid Group, Foss Manufacturing or the like), lamination (flame or adhesive lamination, for example), welding or a combination of these applications.

An adhesive film that eliminates stitching by SewFree may be used to bond fabrics and seams, pocket areas or collars or adhesive bonding by Bemis or the like can attach the seams.

Mechanical bonding can be performed using nylon, elastine, SPANDEX®, or LYCRA® thread or the fibers inclusive in the nonwoven structure or the like. Other equivalent methods may also be employed. Furthermore, as mentioned later, if a Teflon) treatment or the like or encapsulation or nano-technology is used to treat the outer shell material in one or more of the selected preferably composite combinations options, the shell layer is preferably bonded or welded with a breathable adhesive. This is due to the nature of Teflon® materials, nano-technology or encapsulated materials. In some performance categories layer 20 or 30 may be eliminated. The invention may have additional foam, film, nonwoven, web or resin layers added between layer 10 and 40 to accommodate the performance categories or the layers may be comprised of composites with additional layers. Moisture transfer, thermal and waterproof rates will vary with the technical performance needs of the products. There are set standards of rate developed in this invention as the activity and performance level develop the required rates in the end-use product groups.

A detailed discussion of the materials preferably used in these layers follows.

All inner lining materials may include anti-microbial FOSSHIELD silver fibers and grooved 4-8 DG fibers by Foss Manufacturing or the like or X-STATIC® products or the like.

Layer 10 is first layer in the moisture and breathable system. This fabric or nonwoven layer must move moisture and be breathable. A selection of preferable fabrics is discussed below. Additional inner lining moisture transfer fabrics, not listed in this application are included in this invention. This invention includes new blends of nonwoven materials with added technical features to enhance the performance and durability for end-use products.

Selected on the market nonwoven products such as Evolon® have been enhanced with additional shaped and/or fibers and nano-technology to encompass the needs of the moisture transfer, breathable waterproof technical systems. Moisture transfer, flexible, stretchable, breathable and moldable and nonwoven blends developed by Baychar Textiles are combinations of technical fibers constructions and combinations, enhance treatments for waterproof, soil resistance nano-technology, anti-microbial properties and increase durability. These economical composite nonwovens are the suggested flexible and stretchable replacement to LYCRA®, stretch wovens and knits. The suggested and preferably Baychar blended nonwoven composites in layers 10-15 can be used in any layer in this invention or independent of any other layer as a single layer garment. The nonwoven composite can be brushed and fleece or suede like surface. The nonwoven may contain elastine fibers with excellent retention and recovery. The Baychar Textiles nonwoven series is wrinkle free, re-cycleable and can be used for industrial and medical application.

The first suggested fabrics for layer 10 are polyester or polypropylene fabrics or fabric blends made by Coville, Inc. or Deercreek Fabrics. These fabrics may be are treated with moisture transfer ionized solutions, TRANSPORT DRY FIBER TECHNOLOGY, a wetting solution and treatments, nano-technology such as that employed by Schoeller, Toray International, Burlington Industries or the like to enhance the moisture vapor transfer (MVT) properties.

The second fabric is an anti-microbial, antifungal polypropylene fabric with a fleece surface having a polyester, cotton, acrylic, rayon or wool backing, or the like (such as that manufactured by Coville, Inc or Deercreek Fabrics.). This double-sided fabric combines two moisture management mechanisms, wicking and absorption. The wickable synthetic fiber pushes the moisture away and the cotton, rayon, etc. pull the moisture up from the inner layer and spread it out for transfer and evaporation. This double-sided fabric may be used for winter hiking or climbing boots and various alpine boots, the backing made of polyester or cotton blends can be replaced with either natural or synthetic blends of fibers such as wool, cotton, silk, elastine, LYCRA®, SPANDEX®, acetate, acrylics, tencel, rayon, polyester, corn, kapok fibers or the like.

The third material option may be a nonwoven such as that made by Freudenberg called Novolon®, VILDONA® or Evolon® made from microdenier polyester or a microdenier nonwoven with split, wrapped or shaped fibers. This invention further enhances the Freudenberg called Novolon®, VILDONA® or Evolon® with nano-technology, stretchable fibers and foam layers, silver fibers and soil resistant nano particles and coating.

Additionally, this invention further enhances the Novolon®, VIDONA® or Evolon® slit fiber microdenier Freudenberg nonwovens and the moisture transfer Baychar Textile nonwovens and elastomeric composites in this invention with elastine, shaped, hollow, split, silver, grooved blends of synthetic fibers or natural and synthetic fiber blends such as cotton, kapok, wood pulp, hemp, lyocel, a corn fiber by NatureWorks called (PLA)CORNUCOPIA with SPANDEX®, elastine, LYCRA®, nylon.

The fourth material option may further include elastomeric nonwovens by Freudenberg, Alhstrom, Kimberley Clark, 3M®, Gore, North Carolina State Nonwovens Cooperative, or the like.

The fifth material suitable for an inner lining moisture transfer layer 10 is a breathable, moisture transfer nonwoven with elastomeric properties as disclosed in the elastomeric cellular product by Fox Run Technologies and Baychar Textiles. The elastomeric nonwoven products can be easily waterproofed and developed as a single layer garment or portion of the garment.

A preferably the sixth material is an elastomeric nonwoven by Baychar Textiles. This selected blend of combined split, shaped, hollow, silver and stretchable fibers such as LYCRA®, SPANDEX ® or elastine may be combined with a polymer stretch resin to increase flexibility and durability. Additional grooved and shaped fibers by Foss Manufacturing will be added to the nonwoven blends as are defined by the performance needs of the technical products.

These preferable Baychar blends of nonwoven fibers combine synthetic shaped, grooved, split fibers, hollow fibers or the like may be brushed to add a soft, stretchable finish or be brushed to appear fleeced and textured. Combination without resin of natural and synthetic nonwoven blends will preferably contain elastomeric fibers or a layer of foam or both. This invention adds elastomeric stretch fibers, silver fibers and nano-technology to microdenier split fiber nonwovens such as Evolon® and Novolon® or the like to increase the moisture transfer, soil resistance and performance levels and criteria in this technical composite apparel system. The preferable nonwoven blends in this invention blend two or more natural and synthetic fibers such as wool, nylon, elastine, SPANDEX®, LYCRA®, acetate, hemp, rayon, lyocel cotton, corn fibers, KELVAR®, carbon blends with fabric technology to achieve a durability end-use product group for use in composite layers or single garments. As previous stated, the fiber and textile technology combination, rate of moisture transfer, breathability and degree of waterproofing depend on the selected performance criteria and activities.

The seventh nonwoven material group includes a further enhanced moisture transfer, nonwoven with elastomeric properties as described in the elastomeric cellular products by Fox Run Technologies and Baychar patents. The elastomeric cellular composite nonwoven products can be easily waterproofed and used as an entire garment or portion of the composite layer a technical garment.

These preferable nonwoven composites comprised of moisture transfer, nonwoven elastomeric blends are constructed with technical fiber blends treated with nano-technology, silicone, silver technology and/or wrapped with foam or other fibers. The suggested foam coating, Cofoam, coats the exterior of a synthetic fiber or saturates individual natural fibers and allows for increased performance options. Any of the technical nonwoven products disclosed in this invention including the nonwovens by 3mm, Invista, Dupont, Freudenberg, Alhstrom, FoxRun Technologies or the like may be up graded with encapsulated or treated with Teflon®, silicone or nano-technology to provide a multi-functional flexible, single layer nonwoven for technical products. Waterproof, soil resistant, wicking, moisture transfer technologies are added to increase durable, performance and stretchable properties. Elastomeric nonwovens may further be combined flexible, stretchable fibers, films, foams, resins and nano-technology.

Additionally, anti-microbial treatments or fibers may be added to increase the functionality of these technical material and fabric composites. This invention develops the elastomeric, moisture transfer, nonwoven materials into a suitable light weight, waterproof, technical composite garment. The enhanced elastomeric nonwoven material may be utilized for waterproof and breathable technical shell apparel or a shell composite layer for technical soft shell apparel or the like.

Nano-technology may optionally be used to treat the nonwoven fibers or nonwoven layer with moisture transfer, soil resistant, anti-microbial, wicking or waterproof properties. Nano-tex by Burlington, Manomatrix by Toray, NanoHorizon E47 by TTNA, Smartsilver nano-technology and Schoeller soil and waterproof nano-technology is cited in this invention as an example of a moisture transfer, waterproofing, soil repellent nano-technology. Evolon®, Novolon® by Freudenberg or the like, elastomeric nonwovens Baychar Textiles nonwovens containing a polymer stretch resin or stretch fibers, nonwovens, fabrics, films or foam layers in this invention may be treated with nano-technology or a Teflon® treatment to enhance soil resistance, moisture transfer and ionized properties. Elastomeric nonwovens with or without a foam layer may be utilized in the inner moisture transfer layer or the outer shell material in this example with or without anti-microbial properties or in any composite apparel combination in this invention.

The eighth fabric is an anti-microbial, anti-fungal polypropylene/cotton blend or polyester and cotton.

The ninth fabric is a FIELDSENSOR polyester with moisture transfer, waffle weave products or Entrant HB, Entrant V, Entrant GII by Toray. The Toray FIELDSENSOR product AF123, RF123, MX or the like by Toray, construction quickly moves moisture from the surface of the composite and passes it to the second composite layer. Alternatively, a polyester material known as AQUA-DRY, manufactured by Teijin Shojin can be employed.

The tenth fabric is a hydrophilic anti-microbial DRI-LEX nylons or perforated material (such as that manufactured by Faytex Corp.).

The eleventh fabric is a polyester looped terry (such as that manufactured by Kronfli Spundale Mills, Inc. or the like).

The twelfth fabric is a sueded/sanded fleeced polyester microfiber material (distributed by Yagi & Co., Inc. and Teijin Shojin, Inc.) or Smartsilver nano-technology fabrics by TTNA.

The thirteenth fabric is POLARTEC SERIES 100, 200 and POLARTEC POWERSTRETCH which is a wickable, moisture transfer fiber, containing LYCRA® and polypropylene. This fabric is also anti-microbial.

The fourteenth fabric is a moisture transfer fabric CERAMIC FLEECE by Calamai or Cloverbrook fabrics.

The fifteenth fabric is a wool blend with cotton, polyester, or the like backing by Deercreek or the like.

The sixteenth fabric is an acrylic-based conductive fabric from Sterling Performance or ASF fabrics.

The seventeenth fabric is a nylon or nylon polyester blend possibly treated with TRANSPORT DRY FIBER TECHNOLOGY manufactured by Gilford Mills or moisture transfer nano-technology fabrics by Burlington Industries.

The eighteenth fabric is a spacer fabric constructed of nylon, polyester, or polypropylene blend by Dreamfel, Aquafil, Industrias Murtra or the like.

The nineteenth type of fabric is selected chemical and naturally ionized synthetic fabrics and fibers such as (MICROSAFE ACETATE, MICROSUPREME ACRYLIC CYSTAR, BIOFRESH and the like manufactured by Celanese Acetate, Sterling Performance Fabrics, MICROSUPREME HIGH TECH ACRYLIC by Sterling Performance Fabrics.

The twentieth type of fabric is ACRILLIAN or DURASPUN acrylics performance fabrics by Monsanto or blends of acrylics and polyester by Glenoit or the like.

The twenty-first fabric is a blend of performance fibers and TEFLON or FREELON blend of Friction Free Technology by Concept III.

The twenty-second fabric is a new blend of corn fabrics or corn and cotton fibers with wool by Draper Knitting.

The twenty-third fabric is peppered fleece, a combination of cotton, acrylic or cotton, acrylic and polyester The twenty-fourth fabric is KWILL fleece by Concept III.

The twenty-fifth fabric is K-WICK by Kronfli Spundale Mills.

The twenty-sixth fabric is MICROLANA MICROFABRIC by Glenoit.

The twenty- seventh fabric is MICROSUPREME HIGH TECH ACRYLIC by Sterling Performance Fabrics a blend of acrylic, cotton and polyesters fleeced fabrics.

The twenty-eighteenth fabric is NANO-DRY by Burlington Fabrics or a blend of cotton and synthetics with NANO-DRY.

The twenty-ninth fabric is DRI-RELEASE by Concept III Textiles.

The thirtieth fabric is DYERTECH by Dyersburg.

The thirty-first fabric is DRYLINE by Milliken, a hydrophobic polyester and LYCRA®.

The thirty-second fabric is SWEET a polyester fabric by Tapetex.

The thirty-third fabric is a polyester and polypropylene fabric blend by Coville, preferably COMFORTREL. Also preferred are moisture transfer knits by Coville and blends of cotton and polyester and/or polypropylene, preferably HIGHLANDER-PLUS or POLYGON STRETCH.

The thirty-fourth fabric is cross-dye POWER DRY and SMART FIBER fabrics by Wellman.

The thirty-fifth fabric is MICROMOVE by Burlington.

The thirty-sixth fabric is polyester fabrics and blends by Kronfli.

The thirty-seventh fabric is M.C.S. with NANO-DRY.

The thirty-eighth fabric includes the Schoeller DRY SKIN and other inner lining Schoeller fabric or nonwoven PCM materials.

The thirty-ninth fabric is a spacer fabric by Schoeller, BQI, NAM-LION G or the like.

The fortieth fabric is Evolon® or Novolon® nonwoven by Freudenberg or the like.

The forty-first material is a cellular elastomeric composite with stretch fibers.

The forty-second fabric is a MVT THERMAL manufactured by Foss Manufacturing, a needle punch combination of nonwoven fibers and foam.

The forty-third fabric is a MVT THERMAL with wool fibers.

The forty-fourth fabric is a flocked fabric with a knitted, woven or nonwoven face and a flocked fiber backing.

The forty-fifth material is a CHAMELEON or MVT THERMAL by Baychar Inc.,

The forty-sixth material is cotton, organic cotton, wool or a blend of two or more.

The forty-seventh material are fabrics or nonwovens by POLARTEC®.

The forty-eighth material is a stretch polyester material with or without hollow and shaped fibers treated with a wicking solution, NANO-DRY, ionized solution or the like.

The forty-ninth fabrics material by Ventex, Faytex or Malden Mills.

The fiftieth material is a line of cotton, synthetic or stretch fabrics treated by encapsulation by Nextec.

The fifty-first is Schoeller 3XDRY® fabrics.

The fifty-second material is a waterproof breathable fleece by Malden, POLARTEC® or the like.

The fifty-third fabric is DRY-ZONE.

The fifty-fourth material is a nonwoven stretch elastomeric nonwoven or elastomeric cellular nonwoven.

The fifty-fifth fabric are Smartsilver technology fabrics called Nanohorizons E47.

The fifty -sixth fabric group is Entrant series or Fieldsensor series with the Nanomatrix treatment by Toray

CIBA chemical treatments can be added to any of the above fabric or nonwoven selections.

Finally, spacer fabrics or fleeced fabrics of polyester or polyester blends manufactured by Malden Mills and others can be used. A large group of new technical textiles are emerging into the sporting goods industry. This invention incorporates moisture transfer and soil protective technology in or on one or more of the composite layers. Additionally, the technical composite apparel fibers, fabrics and nonwovens layers can be treated to increase benefits with combinations of the suggested moisture transfer and waterproof technologies. Layers 10 through 40 may be treated with a chemical ionization, wicking solutions, nano-technology or a treatment such as COOLAN by KOLON TTA INC., or the like. Optionally, the inner MVT fabric or nonwoven can combination Phase Change Technology (PCMs) and an ionization chemical treatment such as COOLON or Ciba Chemicals.

The chemical ionization treatments place a positive charge or negative charge to the fibers, fabric, nonwoven and/or foam layer and develops an ideal moisture transfer performance product for extreme apparel. All fibers, fabrics or nonwovens may be treated with a patented natural fiber technology to neutralize odor by Stafford textiles or add silver fiber technology. Odor Zapper treats natural cellulose fiber based yarns that function to neutralize odor causing bacteria. All fabrics or nonwovens may be treated with MVT finish, ionized solutions, or NANO-DRY, NANO-TEX or the like.

The first layer 10 abuts a second layer 20 and is attached thereto by lamination, (adhesive or flame) mechanical bonding, ultrasonic bonding, welded or adhesively bonded with breathable adhesives or the like. Additionally, layer 10 may be backed by a moisture transfer thermal flocked fiber selected blend with an environmentally safe adhesive, resin, film, open-cell foam layer, frothed foam, elastomeric cellular composite or a foam and nonwoven blend resin layer. The unique moisture transfer, thermal flocked fiber blend may be optionally attached to the back of the inner lining moisture transfer nonwoven material or fabric presented in first layer 10. The combination moisture transfer flocked fibers may be combined with any layer in this invention and especially with the suggested outer shell materials. The flock may be distributed or spread in a random pattern or a dotted matrix. Optionally, the flocked fiber blend may contain nano-technology or phase change materials or both. The additional thermal phase change properties and nano-technology enhance and increase the comfort levels of the technical garment. Layer 10 the inner lining material or layer 40 the exterior shell may alternatively be attached to a foam composite layer in the technical composite moisture transfer system wherein a flocked layer has been added to the foam composite on either side to add additional performance properties for a component of the technical apparel.

Second layer 20 may be one of twelve options. The first option for layer 20 is a breathable, moisture transferring, reticulated, open-cell, breathable foam layer and fiber blended, elastomeric cellular composite or breathable, reticulated open-cell hydrophilic foam. The foam layer is optionally backed with a moisture transfer, breathable nonwoven top sheet made by Alhstrom, Invista, Freudenberg, Dupont® or the like, or a open-cell, breathable, moisture transfer foam attached to a cellular elastomeric composite containing nonwoven fibers and foam, film or resin or the like. The cellular elastomeric composite is disclosed in the eleventh option for layer 20. The elastomeric composite may optionally be used in any layer in this invention.

The second option for layer 20 is a moisture transfer, needle punch nonwoven or dry-laid, wet-laid or air-laid polymer nonwoven. The nonwoven layer transfers and absorbs moisture and is comprised of synthetic, natural fibers or a blend of these fibers. Silver fibers by Foss, Smartsilver nano-technology or silver treatment may be added to the nonwoven layer or to any layer in the invention. The nonwoven layer may vary in composition as discussed above. The preferred composition for the nonwoven is when use combines wood pulp, cotton, lyocel, polyester, rayon, polypropylene, hemp, corn elastine, or a stretch fiber such as LYCRA® or SPANDEX (or a combination of two or more of these). Of course, the top sheet can contain one fiber and may be treated with nano-technology or an ionizated solution. The top sheet may abut the inner moisture transfer fabric or material or be needled into the nonwoven layer. Optionally, the breathable moisture transfer nonwoven material top sheet may be applied on one or both sides or combined with a foam layer for various types of extreme apparel. The foam layer combined with a nonwoven to sheet can be of any thickness, preferably between 1/20″ and 3/16″. The nonwoven top sheet abutting the foam or included in the foam may also be eliminated in some performance apparel options and replaced with an elastomeric composite. Any nonwoven, spacer fabric or foam layer in this invention may be treated with Phase Change Technology, nano-technology, chemical ionization or a combination of these technologies. Stretchable properties may be added to nonwoven in layer 20. Alternatively, a knitted fabric can replace the nonwoven top sheet in any layer or combination composite layer in this invention.

The third option in layer 20 is an elastomeric nonwoven such Evolon ® Novolon® or nonwovens products by Freudenberg or Alhstrom, Kimberly Clark or the like with or without stretchable fibers or resins. These elastomeric nonwovens may be used as an option in layer 10, 20, or any layer in this invention. Nonwovens by Freudenberg with elastomeric properties are preferred in this invention in active performance categories. However, any nonwoven or knitted fabric that is comprised of absorbent and moisture transferring properties with or without stretchable characteristics can be applied. In some options, tubular knits can be used for a protective gear or skate liner uppers, tongues, heels cups or toe boxes. Alternatively, Split Fiber Technologies and elastomeric nonwovens enhancements developed by North Carolina State Cooperative, Clemson University, Tennessee University, Freudenberg or the like may be included in this invention. Split Fiber Technology may be included within the elastomeric cellular composite layer or elastomeric nonwoven products.

The selected nonwoven or knitted layer when used in layer 20 can be ionized to increase the moisture transfer and enhance performance. The nonwoven layer may contain one or more combinations of split fibers, hollow fibers, grooved fibers, shaped fibers, anti-microbial fibers or treatments. In some options the elastomeric nonwoven layer is the inner lining material or outer shell material selection. Alternatively, a moisture transfer, anti-microbial, nonwoven composite comprised of a moisture transfer nonwoven, breathable, open-cell foam layer abutting or mechanically bonded to another moisture transfer nonwoven layer may comprise the entire liner for a technical soft shell garment, alpine boot, all-weather boot, hockey or ice skate or helmet or the like. The breathable moisture transfer composite system may be enhanced with Phase Change Technologies for additional thermal benefits and may be used as a single layer or composite layer in the moisture transfer system. The nonwoven composite may be used for layer in this invention.

The select nature and shaped, hollow and split fibers synthetic fibers combined in the nonwoven composite layer 20 have inherent moisture transfer and absorption properties and can be treated with a number of MVT surfactants or wicking solution to increase performance. Intera Technology, Ultraphil, nano-technology or the like are treatments that enhance moisture transfer performance. Nano-technology may be applied to the nonwoven fibers to enhance moisture transfer or waterproof the nonwoven layer. Nano-Technology by Burlington Technologies or Toray Industries is preferable.

Nano-technology may be applied to the nonwoven or fabric layer or fibers to enhance the moisture transfer, soil resistant and breathability. Nano-technology by Burlington Technologies or Toray Industries is preferable. Optionally, a hydrophilic foam or foam spray may be applied to the fibers or nonwoven layer to increase moisture transfer performance or waterproof properties. The hydrophilic foam spray application is preferably by Hydrophillx Inc. The microscopic foam spray application may include microscopic thermal fibers, Phase Change Technology, anti-microbial materials, nano-technology, silica powder or the like to increase thermal, moisture transfer performance options for various categories.

The selected rate of breathability, moisture transfer and thermal function is determined by the product and the performance level of the product. The breathable and moisture transfer rates are not ambiguous or undetermined. The selected technical nonwovens and fabrics have determined rates that can be increased or decreased with the applied technologies and selected performance needs of the product line. Fabric or nonwoven venders supplies product test data and performance rates at the request of the product company. Enhancements and additional technology can be added to any layer to increase the functionality and performance for each product category. Soil resistant Teflon® treatments or the like such as applied by Burlington Technologies, Schoeller Textil or the like may be applied to the any layer in this invention.

The third option for layer 20 is an elastomeric cellular nonwoven. The elastomeric cellular nonwoven may be developed in several ways. In the first option, a layer of breathable, open-cell foam and fibers are subjected to water or air pressure on a surface. This may be reviewed in U.S. Pat. No. 6,074,966 and U.S. Pat. No. 6,479,009 B1.

The elastomeric cellular invention process is further developed in this application with a combined wet lay, dry lay and/or conform process.

In the second process option, the fibers, aqueous phase and polymers base are combined in one process under pressure on a surface. The liquid polymer solidifies with the fibers as it reacts to air or the aqueous phase. The selected fiber blend distributed on a screen or bed, fuses with the liquid polymers, aqueous phase and solidifies under pressure into a nonwoven composite. The polymer base reacts and solidifies as the aqueous phase is combined and the fibers are fused together with the solidifying polymer under pressure. Alternatively, the fibers, aqueous phase and the polymers base may be integrated and combined prior to the surface integration.

The polymer base and aqueous phase combine during the water or air pressurization with the fiber mesh. All three nonwoven and foam process options may incorporate synthetic and natural fibers and include ionized treatments, nano-technology and or phase change materials.

The elastomeric cellular nonwoven may be fused under air, water or magnetic pressure with another open-cell foam layer and/or polymer mesh. A polymer film or resin may replace the open-cell foam structure in some options.

The fourth option for layer 20 is a nonwoven with treated with thermal characteristics. The nonwoven is formed by a dry-laid, wet-laid, air-laid or polymer-laid method. The nonwoven may be a top sheet attached to a selected elastomeric nonwoven capable of absorbing and moving moisture. The thermal options for this nonwoven layer may include Phase Change Technology, or thermal fibers or both. The thermal nonwoven alternative to the MVT composite system may be THERMOLITE, THINSULATE, SSOFTHERM, PRIMOLOFT, OUTLAST or Phase Change Technology nonwoven, Schoeller PCM nonwoven or the like or a combination of one or more of these products with foam. Preferably, the thermal nonwoven and foam combination is a MVT THERMAL or CHAMELEON developed by Solid Water Holdings. The MVT THERMAL is detailed in the eighth option for layer 20. The THERMOLITE nonwoven by Invista may additional contain grooved and shaped fibers and foam. The hollow fibers in the THERMOLITE nonwoven layer and be shaped or grooved to increase moisture.

THERMOLITE may be combined with the MVT Thermal by Baychar Holdings in some options in this invention.

The fifth and sixth option for layer 20 is a spacer fabric or a spacer fabric and foam combination. The spacer fabric is constructed in one option with two knitted top sheets one on either side of a bed of fibers such as developed by Muller Textil. This invention further develops a spacer fabric sandwich-like construction replacing the knitted top sheets with a wet-lay or spun bonded nonwoven material on either side of the fibrous bed. The spacer fabric top sheet construction may optionally be a woven, a knitted-wovens combination, a nonwoven, a double-sided fabric or a combination of any of these selections on either side of a bed of continuous filaments. Alternatively, these top sheets on either side of the continuous filaments may be a combination of fiber and foam and may contain shaped, hollow and grooved fibers. This nonwoven composite sandwich construction produces a cushion-like material and provides rebound and moisture transfer properties to the MVT composite system. The sandwiched fibers in the spacer fabric in between the knitted top sheets or bed may also be altered to increase performance. Shaped, hollow, grooved, split or smooth fiber can be added to improve moisture movement through the spacer products. In one example, the filaments are shaped 4-8 DG polyester fibers in both the top sheets and in the bed. This engineered space fabric may be applied in layer 10 to 40

The grooved fibers may additionally be hollow in the top sheet exterior layers or the fiber bed. Anti-microbial silver fibers, wicking and nano-treatments may be added to the layers of the spacer fabrics or any layer in the composite apparel. In another example, the spacer fabric bed is a combination of hollow, grooved and/or shaped filaments attached to a foam layer on one side and nonwoven layer on the other side.

As mentioned above, the top sheets located on either side of the nonwoven fibrous layer can be constructed of a number of combinations depending on the performance criteria required in the product. A cellular elastomeric composite may be placed on either side of the fiber bed and replace the nonwoven or knitted top sheets.

In option seven, a down feather layer may be used as layer 20 or combined with any of the layers suggested in layer 20. In fact, a down feather layer may be the insulated layer provided in a number of alpine solutions in this invention. The down feather layer such as that developed by NAPTURAL in France can be provide between layers 10 and 40 or may be used in combination with other composite constructions in this invention. The down layer may be alternatively treated with a nano-technology or ionizated chemical solution to increase the MVT performance. The down layer may be replaced with kapok for water sports soft shell composites.

The eighth option is a nonwoven and foam composite MVT THERMAL composite are comprised of synthetic shaped 4-8 deep groove polyester, acrylic, acetate, polymer fibers, silver fibers, natural fibers or a blend and an open-cell foam or polymer with or without Phase Change Technology, silica particles, air or gel spheres and anti-microbial properties. This MVT nonwoven and foam composite may include silver fibers by Foss Manufacturing and is manufactured under the trade name CHAMELEON or MVT THERMAL by Solid Water Holdings This all-in-one needle punch technical nonwoven, spun bond or wet-laid product is thermally regulated by fiber content, silica, air micro-spheres, PCM Technology, nano-technology and shaped or grooved fiber combination. The technical nonwoven composite transfers moisture immediately through the layers. The natural fibers such as wool, lyocel, hemp, wood pulp, silver, copper or a blend may be added to the MVT composite to increase the thermal and moisture vapor transfer. The MVT composite is quick drying and anti-microbial. The MVT THERMAL composite may be more or less thermal depending on the fiber content and foam selection, cell density and thickness and may include a cellular elastomeric layer needled into the nonwoven fiber layers. Optionally, the cellular elastomeric, foam and nonwoven composite include synthetic or natural fibers blends such as wool, cotton, lyocell, acrylic, polyester, nylon, stretch fibers or the like as discussed above. An acrylic web by Naltex or the like may be included in the MVT nonwoven composite or placed on the surface of the nonwoven composite with or without PCM's. The acrylic web may be further treated or include a number of wicking and thermal technologies to increase the performance of the MVT THERMAL or nonwovens layers in this composite and invention. Nano-Tex Technology can be added to this MVT THERMAL or to the CHAMELEON composite to increase the drying time. In a number of options the MVT THERMAL or CHAMELEON has mechanically bonded a layer of THEMROLITE, THINSULITE, Freudenberg COMFORTEMP or PCM nonwovens into the layers creating a range of thermal properties and values in the layered MVT system. The MVT THERMAL composite may be made comprised of wool, 4-8 DG polyester, silver fibers and a blend of other natural synthetic fibers for all weather and hunting boots. The MVT THERMAL or CHAMELEON composite may be used in layers 10 through 40 in this invention and may be comprised of foam and nonwoven, nonwoven foam, nonwoven or foam, nonwoven and foam construction. This MVT composite is antimicrobial, MVT and can be more or less thermal with the addition of fiber, PCM or both. The MVT THERMAL anti-microbial composite may have nano-technology and/or air-gel added to enhance the composite performance. Air-gel can be added to any layer in this apparel composite or treatment. The MVT THERMAL may be combined with THERMOLITE by Invista or Thinsulite by 3M®.

Layer 10, 20, 30 or 40 or additional layers may optionally be a MVT THERMAL manufactured by Baychar Inc. and Foss Manufacturing or a combination of a MVT THERMAL and an elastomeric composite or thermal as suggested above in option eleven for layer 20. In some performance categories the composite apparel is constructed with a inner lining material or fabric and a nonwoven and foam composite and the outer shell. In another option the inner lining material abuts a nonwoven thermal with PCM and the waterproof breathable outer shell material. Optionally, the moisture transfer, technical apparel composite is developed by attaching the inner lining material to a MVT THERMAL comprised of a thermal nonwoven and an open-cell, breathable, foam mechanically bonded with or without PCM, air or silica spheres and the waterproof breathable exterior shell fabric in layer 40 or additional layers.

The MVT Thermal contains natural and synthetic hollow, shaped, grooved, elastomeric, split fibers or a blend of these fibers. This performance apparel MVT composite system develops both a waterproof and moisture transferring soft shell apparel sports application. Teflon® treatments or the like or encapsulation by Toray or Nextex or the like or nano-technology, waterproof films, DWR treatments or waterproof breathable adhesives or membranes may be used in any exterior shell material or fabric in this invention. The MVT THERMAL may include a layer of THERMOLITE or THINSULITE in the composite nonwoven layers or a layer of Comfortemp or Schoeller PCM nonwoven.

The ninth option for layer 20 is an elastomeric cellular composite by Foxrun Technologies. The elastomeric composite option is mentioned above in option one. The electrometric composite may abut layer 10 and the exterior shell layer in layer 40. This extremely thin composite creates an all-in-one product. A membrane may be included between the elastomeric composite and the outer shell fabric or material in layer 40 to waterproof the product or layer 40 may be treated with a waterproof breathable film or encapsulation to waterproof the product. Nano-technology may be added to the elastomeric layer or the membrane abutting the elastomeric composite or may be combined with the exterior shell fabric or nonwoven layer. Bionic finishes from Rudolf Chemie under the brand name BONIC-FINISHO can be applied to the outer shell material. Ruco-Dry products are a new class of water repellents and they are free from flurocarbons polymers. Rucostar products develop oil and water repellency with reduced flurocarbons. Another oil and water repellent product by Milliken called STAINSMART® may be applied to the outer shell material to prevent stains and provide water repellency.

The tenth option for layer 20 is a MVT felted product comprised of natural, synthetic or a blended of fibers made by Baychar Holdings, Invista, Freudenberg, 3M or the like. The felted product may be used in layer 10, 20, 30. Silver fibers may be added to enhance thermal and anti-microbial properties. This antimicrobial, MVT felted liner can be more or less thermal with the addition of fiber, PCM or both.

The eleventh option for layer 20 is a cellular elastomeric option. This tissue thin cellular elastomeric composite can vary in fiber content and polymer or foam composition as mentioned above. The cellular elastomeric composite is extremely flexible and may include elastine or stretch fibers, a film, a polymer stretch resin, silver fibers and numerous combinations of natural and synthetic fibers blends. The cellular composite may vary in thickness, stretch and in strength and may be a washable or a disposable product. The elastomeric composite is made of foam fused together with synthetic or natural or a blend of these fibers or a film resin fused together with nonwoven fibers. The elastomeric composite can be applied in layers 10 through 40 and may have fibers flocked into either side of the elastomeric composite. Optionally, the elastomeric composite and foam and nonwoven composites may contain or abut a netting or acrylic web to provide strength, stretch, MVT and/or thermal enhancement. The polymer web or netting may abut or be included in any of the foam or nonwoven layers in this invention. Preferably, an acrylic web developed by Freudenberg is suggested in this selected performance option. The elastomeric composite may abut layers 10, 20, 30, 40 or optional layers. The elastomeric composite may be positioned between layer 10 and 40 or may be a single layer product. Optionally, the elastomeric composite may be treated with a soil retardant solution, a Teflon® product or the like or a waterproof encapsulation or nano-technology.

The elastomeric composite may be welded, adhesively bonded, laminated or quilted in this extremely thin 1-5 layer composite system for apparel or footwear products. This all-in-one thin MVT composite product may be wind and waterproof. The elastomeric composite layers may contain any synthetic or natural fiber. Preferable fibers include nylon, KEVLAR®, acrylic, wool, lyocel, polyester or stretch fibers such as elastine, LYCRA® or SPANDEX®. The liquid polymer or film is fused together with dry laid or water jet technology process with fibers. The liquid polymer and fiber base make an excellent carrying agent for a number of particle-based technologies such as PCM, air spheres, silica or the like. The liquid polymer solidifies under heat, water, air or magnetic pressure with the fiber base to a flexible substrate and develops numerous options for interlinings and commercial products. Optionally, a film stretch resin is fused together with the nonwoven fibers. The cellular elastomeric composite is disclosed in U.S. Pat. No. 6,074,966. This invention includes and enhances the elastomeric composite invention by Foxrun, U.S. Pat. No. 6,074,966, and further invents the incorporation of a new development process to form the elastomeric composite, and shaped and grooved fiber options, new technology and materials including nano-technology, Phase Change Technology, ASPEN air gel, chemically ionizated fibers and web matrix into the elastomeric cellular composite. The elastomeric composite may be combined with the thermal nonwoven by mechanical bonding, lamination or welding. The elastomeric may be combined with a spacer fabric. The elastomeric composite may have shaped fibers, hollow fibers, silver fibers, wrapped fibers or a blend and be treated with a chemical ionization to increase the MVT properties in the composite. The elastomeric composite may be used by itself in any layer or in combination with any layer in this invention and especially in combination with a foam, a spacer fabrics, exterior shell material or nonwoven layer. The elastomeric composite may be combined with MVT THERMAL composite nonwoven, the Freudenberg COMFORTEMP nonwoven, Schoeller PCM nonwoven, nano-technology, PCM technology, a membrane or coating.

All the foam materials discussed herein are preferably AQUAZONE or VPF, Free rise foams made by Foamex, or the like or the foam layer may be an open-cell frothed foam or slap foam. This open-cell, breathable foam layer may be incorporated with any layer in this invention. In some performance categories, the frothed foam may be combined with a moldable polymer mesh to enhance product performance and strength. The open-cell foam or frothed foam may add natural or synthetic fibers, a net or polymer web matrix, Phase Change Technology, silica powder, air spheres, nano-technology or air gel technology spheres by ASPEN or the like. ASPEN air gels and nano-technology can be added to any fiber, fabric, foam, spacer material or nonwoven in this invention to increase the insulated values, MVT performance or waterproofing characteristics in the composite.

Optionally, the moisture transfer, frothed foam layers may be applied to any nonwoven, foam or fabric surface in a dot matrix with our without nano-technology, Phase Change Technology, air spheres, silica or the like.

The frothed foam when selected for layer 20 or 30 may be combined with natural or synthetic fibers or in some cases the frothed foam layer may include a net or polymer web technology, a waterproof membrane or a film. The membrane or film are optional and are used to add flexibility, structure and waterproof options for protective gear. The membrane is eliminated in a number of performance categories if the outer shell fabric or nonwoven material is encapsulated by Nextec, Toray, Kolon or the like or is knitted-wovens treated to repel water or if the NANOSPHERE Technology has been added to waterproof the exterior shell in layer 40. A waterproof membrane or film may be combined with the exterior fabrics or nonwovens containing nano-technology, encapsulated technology or waterproof, knitted-wovens layer in the MVT system in some exterior performance apparel and footwear applications.

A number of patents have been issued to Triangle Research & Development Corp. disclosing details related to the processes now being employed by Gateway Technologies, Schoeller Textil, Freudenberg COMFORTEMP, Outlast Technology, and Invista. For example, U.S. Pat. Nos. 4,756,958 and 5,366,801 are directed to fibers and fabrics with reversible enhanced thermal properties respectively. The disclosures of these two patents are hereby incorporated by reference. Other patents assigned to Triangle Research and Development Corp. that are related by subject matter and have overlapping inventorship, include U.S. Pat. Nos. 5,415,222, 5,290,904, and 5,244,356. These patents are also hereby incorporated by reference.

The twelfth option for layer 20 is a flocked fiber composition. One preferred option is composed of grooved and shaped polyester fibers and a synthetic and natural fiber blend manufactured by Foss Manufacturing and Claremont Flock or the like. The flocked fiber blend with or without silver fibers can be applied to any layer in this invention to increase the MVT and thermal options in each layer. The silver fibers are anti-microbial and thermal. The flocked fiber composite added to the back side of the inner layer fabric may abut layers 20, 30, or 40 or the flocked fiber combination may be added between layer 10 and 40 comprising an extremely thin composite apparel. Alternatively, a group of selected nonwoven synthetic or natural fiber blends may be flocked into the open-cell, elastomeric composite or spacer fabric in the layer 20, 30 or the fibers may be flocked to the back side of the inner lining fabric or material or the outer shell exterior fabric or material. Any layer or layers in the invention may be eliminated or combined in some performance categories with the flocked fiber composition. For example, the inner lining MVT material may backed by a foam or film. The MVT Thermal flocked blend would be attached to the back of the foam and in-between the exterior shell layer 40. The technical MVT composite system is welded, adhesively bonded, stitched or laminated to layer 40 creating a MVT system and product. The MVT Thermal flock fiber blend may be added to the back of layer 40 with an adhesive foam or film and abut a foam layer, elastomeric composite or MVT Thermal composite and the inner lining material or fabric and may be combined in the same manner as stated in the previous options. The MVT thermal flocked fiber is anti-microbial and is unique in its fiber selection and shape. The fibers are hollow, split, shaped, grooved or with or without sliver Fibers. This unique blend of natural and synthetic flocked fibers increases the thermal and moisture transfer performance and anti-microbial properties in the moisture transfer composite system. The MVT thermal flock is attached to a elastomeric composite layer in between layer 10 and layer 40 creating another option for a technical MVT system and product. The MVT flocked fiber blend may be flocked to any layer in the MVT composite system including nonwovens, foams, films and membrane surfaces or the flock may be applied to the actual fiber filament. In some performance categories the thermal flocked MVT layer is the inner lining surface layer attached to a fabric, foam, membrane, film or a nonwoven substrate. In one example, a MVT Thermal flocked fiber blend is applied to the surface of the nonwoven base and used as a technical composite layer. This technical nonwoven MVT Thermal flocked nonwoven composite layer is optional and may be mechanical bonding, adhesive or fused to another nonwoven composite creating a technical insulated material for extreme temperatures.

A similar layer of MVT thermal flocked fibers can be added to frothed foam base, slap foam or open-cell free rise foam. A second foam layer can applied after the fibers have been added to the base foam. This stretchable, sandwich construction comprised of foam and MVT flocked fibers creates a foam composite for extreme temperatures. Both the foam and nonwoven composite mentioned above may additionally include an internal matrix web enhance the MVT performance and increase the waterproof attributes of a product. Both composites may include Phase Change Technology and be combined with a soft-shell fabric.

The MVT Thermal flocked fibers are natural or synthetic or a blend of fibers. The flocked fiber blend may contain wrapped fibers, hollow fibers, shaped channel fibers such as 4 to 8 DG polyester or alternative polymer fibers. The MVT flocked blend may contain a number of enhancing additives such as silica powder, air spheres, microspheres with PCMs (Phase Change Technology), ionized particles. The MVT flocked fiber blend may be treated with an ionized solution to enhance the MVT properties or NANO-TEX or NANO-DRY. The flocked MVT composite is especially recommended for a single layer exterior shell woven or knit fabric or nonwoven. The flocked composite with an environmentally, friendly adhesives is applied to the back side of the shell fabric or material layer. The all-in-one layered MVT composite fabric, material or nonwoven creates a total package for shell garments and performance apparel, activewear, footwear, helmet liners, shoulder strips, back packs, or the like. A preferred embodiment is a MVT thermal flocked blend applied to a elastomeric composite or foam layer and a exterior shell fabric or nonwoven. The MVT thermal flock contains a blend of natural and synthetic fibers such as wool, lyocel, SPANDEX®, elastine or the like, shaped polyester fibers with or without silver fibers. The shell fabric is elastomeric and waterproof.

This moisture transfer composite or flocked treatment to the exterior shell fabric or material develops an all-in-one environmentally friendly, breathable waterproof, thermal, MVT, antimicrobial and extremely light and flexible garment. Optionally, a flocked fiber combination can be applied in a dot matrix pattern to a nonwoven, foam or fabric surface. The MVT thermal flocked fiber blend can be distributed in a dot pattern or random pattern on the foam, nonwoven, fabrics, adhesive or films surface. In some performance option the flock composite blend contains nano-technology and or phase change technologies.

If desired, a membrane, film, flock or coating with or without PCMs, nano-technology air spheres, or gel spheres may be laminated between the first layer 10 and the second layer 20 or any layer in this invention. Optionally, the membrane, film or coated layer may have a flocked fiber blended applied to the surface between layer 20 and third layer 30 or third layer 30 and the fourth layer 40 or optional layers. Layer 30 may be a membrane in some performance categories. A coating with microscopic acrylic PCM's, gel or air spheres or the like may be added to the coating and included in the nonwoven or foam in layer 20 or 30. A polymer or foamed coating with or without PCM's, air, gel, silica, spheres, MVT enhancements optionally can be applied to the fibers in the nonwoven or fabric layers in any layer in the composite system. The foam enhancing treatment may be applied to foam, nonwovens, synthetic or natural fibers or to the fabrics in this system by Hydrophilix Inc. The hydrophlix foam application may be applied to the back of the inner or exterior shell fabric or nonwoven. Alternatively, an acrylic web matrix or an acrylic or polymer or foam dot matrix may be applied to a layer of nonwoven or foam, the MVT THERMAL, or spacer fabric or spacer fabric and nonwoven in layers 20 or 30 or added to the back of the MVT fabric in layer 10 or exterior shell fabric in layer 40. The acrylic dot matrix pattern makes an excellent carrying agent for PCM's air spheres, gel or MVT enhancement materials or treatment or the like and increases the flexibility and strength of a layer and performance attributes of the MVT composite system. All fibers, fabrics, foams and nonwovens can be treated with a wicking solution to increase the moisture transfer properties and characteristics.

The Outlast membrane with PCM Technology, Phase Change Technology in a binder, film or frothed foam disclosed by Gateway Technologies may be laminated or incorporated with the foam, nonwoven, fibers or fabric or the PCM Technology may be embedded in the AQUAZONE, open-cell foam, fibers, nonwoven layer or fabrics or the like, COMFORTEMP Technology, SCHOELLER, PCM Technology and Outlast Technology are microencapsulated technology which depending on the application can provide either warming or cooling. If Schoeller PCM Technologies is selected, hydrophilic foam is used in the layer 20 and is referred to as COMFORTEMP or Schoeller PCMs. COMFORTEMP may be a foam layer or a nonwoven layer with PCMs. The COMFORTEMP nonwoven is manufactured by Freudenberg and may be an option in any layer in this invention or combined with any layer in this invention. This invention employs VPF or AQUAZONE, or a hydrophilic/open-cell free rise, slap or frothed foams or coating with Phase Change Technology. The foam may be or may not be embedded with the PCM Technology and/or natural and synthetic fibers.

The addition of the Phase Change Technology to melt blown nonwoven fiber is presently marketed by Outlast as THEMOCULE, Invista fibers and nonwovens with Phase Change Technology, nonwovens by Freudenberg as trademarked as COMFORTEMP nonwovens or by Schoeller Textil trademarked Schoeller PCM. The PCM nonwoven developed by Schoeller, Freudenberg, Alhstrom, 3MM, Outlast or Invista products or the like with Phase Change materials can be used in any layer in this invention or combined with any layer in this invention. The Outlast/Invista nonwoven with PCMs, Schoeller nonwoven or Freudenberg PCM, 3MM, Alhstrom nonwoven thermal fibers with Phase Change, THERMOLITE with or without Phase Change Technology or THINSULITE with or without Phase Change Technology or THERMOSENCE by Wisconsin Global Technology or a down technical filling by NAPTURAL is an option in layer 20 or layer 30. Layer 30 may be a thermal nonwoven such as THERMOLITE, THINSULITE or PRIMOLOFT or any insulated nonwoven product. In one option layer 30 has microspheres containing air in a binder applied to a nonwoven or fabric backing. All synthetics and natural fibers, fabrics and nonwoven layers in this invention may have the option to be treated with Phase Change Technology, nano-technology or a micro-sphere technology to increase the moisture transfer and thermal properties in the fiber or layer. This invention is inclusive of any coating, additive, treatment or fiber that increases the thermal or MVT characteristic of the layers in the MVT system. All the insulated materials listed above may include kapok or wool fiber or a blend to increase thermal and floatation properties. THERMOLITE and THINSULITE are additionally enhanced with anti-microbial properties and split, shaped, grooved, stretchable elastic fibers and/or hollow fibers. A blend of one or more natural or synthetic fibers can be added to the THERMOLITE or THINSULITE nonwoven to increase thermal and moisture transfer performance. Optionally, a layer of foam may be mechanically bonded to the THERMOLITE or THINSULITE layer to increase the thermal and moisture performance levels.

The MVT layered system disclosed as 1-4 layers may have additional layers or may be one layer with multiple functions. The addition of membranes or films as suggested or thermal nonwoven or foam layers may be applicable in the development for extreme apparel and footwear products. The MVT system may also be an all-in-one product layer described as a flocked fabric or material or a flocked thermal composite developing a single layer composite product. In one alternative the flocked fiber, antimicrobial blend is added to the back of an inner MVT fabric or material layer 10 or the back of an outer shell material or fabric layer 40. This one layer composite system is extremely thin and can be worn as a shirt, pants, jacket or the like. For example, in the water sports apparel category the exterior shell waterproof material may be backed with a MVT Thermal flock fiber blend and promote warmth and dryness in the inner atmosphere of the surfing or diving suit. The flocked fiber composite blend can be added to the encapsulated exterior shell denims, cottons, wools and wool blends, Cordura® nylons, stretch Cordura® or any inner lining or shell fabric or material. In fact, any structural knitted or woven fabric or nonwoven may have a MVT flocked system applied to one side or both, and these flocked fiber layer composites may be used as a completed product line or may be incorporated into this multi-layered MVT system. The flocked fiber blend incorporates a breathable and environmentally friendly adhesive. Optionally, this extremely thin composite MVT flocked layer may be applied to the back of any layer in the MVT system.

The combination of the foam and top sheet forming second layer 20 can be produced in at least three different ways. According to one way, second layer 20 is produced by laminating or welding a top sheet to the foam. According to another way, the second layer 20 is a cellular elastomeric composite in which the top sheet and the foam have been fused together by water pressure. If the elastomeric composite is used in layer 20, then it is suggested the composite be needled or welded to layer 10, 30 or additional layers. A complete description of the elastomeric composite is disclosed in U.S. Pat. 6,074,966 and other patents and applications by Frank Zlatkus. In some options, layer 20 can be omitted and the MVT THERMAL or the foam abuts layer 40 or additional layers. All breathable foam layers in this invention may have added synthetic or natural fibers or a blend of fibers or polymer mesh to increase performance properties.

Any layer in this invention can be omitted to accommodate the product criteria. Any layer in this invention can be chemically ionizated, treated with nano-technology to increase the MVT rates and drying rates. The exterior shell fabric is presented in the invention as waterproof, but in some performance categories waterproofing is optional. In several performance categories layer 20 is eliminated and layer 30 becomes the layer 20.

The third layer 30 much as layer 20 may vary in material and composition with the performance criteria. Layer 30 may be a stretchable nonwoven, foam, nonwoven and foam composite, spacer fabric, spacer fabric and nonwoven or foam combination, an elastomeric composite, a membrane, film or the exterior shell fabric depending on the performance category. If the third layer 30 is a breathable membrane or film or includes a breathable membrane or film, it is preferable to select one of the suggested membranes or films: TX1540 by Shawmut Mills, SECO-TEC, THINTECH, LAYTEK, WITOFLEX SYMPATEX WINDLER, SYNTHETIC ELASTIC, ENDURANCE TRIAD, STORM TEX, DARTEX COATINGS, ACCUVENT, eVENT, AQUAPHILE, Super Dry Film by Bazenden Chemicals (a water-based hydrophilic polyurethane membrane) membranes, treatments or films by Harrison Technology or Ciba Chemicals such as DURAPEL PLUS, TRAVTECH, HYPER DWR, ENTRANT G-XT OR eVENT FABRICS or the like. Nano-technology may be included in layer 30 with the nonwoven or membrane. A spacer material may be added to any layer 10 to 40 with or without Phase Change Technology, coating by Darlex Coatings, breathable membranes or nano-technology or the like. The nano-technology, Teflon® treatments, coatings, films or membranes can be added to either side of the spacer material or fabric.

The waterproof/breathable membranes may be combined with Phase Change Technology, silica micro-spheres and acrylic micro-spheres with air, gel or the like. The breathable membrane or breathable films can be applied to any layer in the invention. The breathable membrane and films absorb the outgoing moisture and transfer it to the garment surface while providing a waterproof barrier for the garment. The membrane, coating or film or polymer stretch resin is laminated to the inner side of the outer shell fabric, but can be applied to any layer in this invention when necessary. A film, polymer stretch resin, or coating may be applied to the exterior shell fabric to provide waterproofing in the absence of the membrane, nano-technology or encapsulated fabrics. In some performance categories a membrane may be combined with a fabric that has been treated with a waterproof film or coating to increase the waterproof protection. If the outer fabric is encapsulated, treated with nano-technology or structurally woven to repel water, the breathable membrane is not necessary. Optionally, a thermal foam spray applied to the shell fabric to increase thermal performance and enhance wind resistant properties. For colder conditions, such as for temperatures below 32° F., an additional insulating layer may also be provided along with the PCM membrane or coating. PCM Technologies can be added to a thermal spray, coating, polymer stretch resin or the surface of a membrane or film to increase the thermal performance. This insulating layer 20, or 30 is preferably THERMOLITE thin or EXTREME (manufactured by DuPont®), a hydrophilic foam with or with out PCM, with a spacer fabric or the MVT THERMAL composite, elastomeric nonwovens or composites or the like. All layers and fibers can be optionally treated with a chemical ionization, an electrically charged solution to increase the MVT performance levels or nano-technology.

Preferably, the breathable membrane may be inserted between layer 30 and 40. The THERMOLITE line of nonwoven owned by Invista/Koch Industries can be treated with chemical ionization to increase the moisture transfer properties, and the PCM can be contained in a nonwoven microsphere comprised of a polymer and fibers, an air, polymer or silica sphere or a gel base to increase the thermal capacity of the nonwoven layer. THERMOLITE, 2000/PLUS/STANDARD/1300series etc., SSOFTHERM or THINSULITE can be needled laminated, or welded to the MVT THERMAL composite by Baychar and Foss Manufacturing. Alternatively, this layer, like others, can be omitted entirely in certain applications. Holofibers by Wellman or shaped fibers can be added to any layer or insulative layer in this invention.

The fourth or outer shell layer 40 abuts either the laminated breathable membrane, breathable waterproof film, flocked fiber composite as mentioned above, a foam, a foam composite with fibers, mesh spacer fabric or a combination, a nonwoven or an insulating nonwoven, nonwoven and foam, a nonwoven with a polymer web or nonwoven with a dotted pattern with or without PCMs, a MVT THERMAL composite, SSOFTHERM both manufactured by Foss Manufacturing, the elastomeric composite material, a spacer fabric, a spacer fabric and foam composite, an adhesive, a film, or acrylic or polymer web matrix in the third layer 20 or 30. If the outer layer is a material that is encapsulated by Nextec, Toray or the like, or if it is a performance fabric such as DERMIZAX by Toray, or MICROFT, which is distributed by Teijin Limited, then the third layer 30 abuts the fourth layer 40, but is not laminated thereto. Technical textiles are continuously developing to include fiber treatments that waterproof the exterior shell materials and fabrics. This invention covers waterproof treatments and applications to the fabric, nonwoven or shell material, inner lining material abutting the exterior material, nonwoven or shell fabric or the inner layers of the nonwoven, material or shell fabric. The boundaries formerly defining a fabric or a nonwoven have begun to merge. Knits, spacers, nonwovens, films, webs and wovens are combined into technical composite textiles or constructions merging the lines between woven and knitted fabrics, and nonwovens. Synthetic and natural fibers may be microscopically wrapped, included in or fused with polymers, foams, resins, membranes or films and are defined as either a nonwoven or a material. Many of the technical definitions for a nonwoven and fabrics are merging and re-defining the technical composite history. This invention addresses the technical composites soft shell apparel, medical and industrial applications.

All fibers, fabrics or nonwovens listed below may be treated, coated, impregnated or thermally bonded by Strahm Textiles or the like. The outer shell material may be treated with a UV protective. The UV treatments may be incorporated into the fiber, fabric or nonwoven layer or may be applied with a waterproof coating or include with a Bionic Finish.

The following is a list of outer moisture transfer materials that could be used as the outer layer 40:

Cotton-polyester blend with a breathable membrane, encapsulation, nano-technology, or Bionic Finish. (several choices);

Cotton blend encapsulated with or without Bionic Finish;

Cotton and wool blend encapsulated with or without Bionic Finish;

Cotton denim or chino encapsulated or nano-technology;

Cotton denim or chino waterproof breathable membrane;

Wool fabrics or nonwovens with encapsulation, nano-technology, Bionic Finish or a combination;

Stretch fabrics COMFORTREL XP® SENSURA® SPUNNAIRE® COMFORTREL PLUS® ULTURA®;

Dri-Release performance fabric;

ASF fabric with IST Technology;

Anti-friction fabrics by Sheehan;

⅔ ply Supplex encapsulated;

⅔ ply Supplex waterproof breathable membrane;

6-ply Taslan encapsulated/waterproof breathable membrane;

Tudor by Travis encapsulated/waterproof breathable membrane;

Mojave/Twister by Travis encapsulated/waterproof breathable membrane;

Cordura® encapsulated/waterproof breathable membrane;

Micro-Technical II sanded or Micro-Technical III Sanded by Brookwood encapsulated or membrane;

Citation Sanded or Jet-Laund by Brookwood encapsulated or breathable membrane;

Encapsulated Supplex by Toray;

Dermizax fabrics by Toray;

Entrant Gil by Toray;

Super-microft distributed by Teijin Shojin or ASF;

Lothian coated fabrics;

Tweave stretch fabrics;

Sensitive stretch fabrics;

POLARTEC® fabrics and nonwovens;

Gymstar Plus by Unitika;

Tuflex-HR by Unitika;

Schoeller WB-400;

Schoeller Dryskin;

Schoeller encapsulated fabrics;

Schoeller Dynamic Extreme;

Schoeller Keprotec;

Schoeller Dynatec;

Schoeller Keprotec with lnox;

Schoeller NanoSphere fabrics;

Schoeller WB 400 fabrics;

Schoeller Kevlar, Cordura® or composites with foam, nonwovens or both and PCMs;

Nam Liong, Toray, Teijin Shojin exterior shell performance fabrics and materials;

Micro-polyester fabrics distributed by Teijin Shojin;

Structurally knitted acrylic wool, with or without encapsulation (made by Toray), distributed by Teijin Shojin or ASF Group, Kyodo Sangyo Co. Ltd. (a structurally knitted fabric that repels water);

Vinyl materials with a nonwoven backing and plastics fabrics by Tessile Florentina, Baikfan, or Teijin Shojin, these groups include Errebi, 101659-01669-01676-1271, 57006-800, and 43005-870;

Somatex, which is a neoprene type of material that is breathable;

Darlexx, which is a LYCRA® type of material and is to be used in the underarm portions of certain apparel;

Kolon HIPAN-Coolskin;

GoreTex soft shell composites and fabric;

Schoeller PCM composite constructed of exterior shell fabric with or without nano-technology, PCM foam and a knitted or nonwoven top sheet, or Schoeller exterior shell fabrics, foam with or with out PCM and a nonwoven top sheet with PCM Technology;

Kolon HIPAN-THERMOSKIN or HIPAN-CLASSIC;

Kolon waterproof, MVT and stretch fabrics;

Consoltex 4 way stretch fabrics;

Hipora waterproof breathable fabric by Kolon;

Toray Stunner QD family of fabrics;

Toray Cebonner hollow fibers denim fabric;

Freudenberg Nonwovens such as Evolon®, Vilon® and Novolon®;

Stretch elastomeric nonwovens by Baychar Textils, FoxRun Technologies, or the or the like;

Evolon® VIDONA ® and Novolon®;

IBQ fabrics

Ripstop Hardline fabric; and

Wool and wool blends which include one or more of the following: acrylic, LYCRA®, LANTOL® by DuPont®, polyester, cotton, lyocel and nylon. These fabrics are made of yarns and are hydrophobic. Wool and wool blends are provided by Euromotte, Inc. of Belgium, and/or Toray in Japan. These fabrics are either pure wool, wool blends, or acrylics that are knitted with hydrophilic yarns so as to be waterproof. This is in effect an encapsulation process or treated with a nano-technology.

Any fabric or nonwoven in the exterior shell layer can be treated with waterproofing by DWR, Teflon® or silicon treatments or the like membranes, coatings, encapsulation, films, wrapped fibers, internal webs and/or nano-technology. The nano-technology, microscopic treatment creates a chemical sleeve or framework around the fiber and enhances the selected performance criteria. Nano-technology Teflon® or silicone treatments can be applied in a spray to a fabric or nonwoven surface to waterproof and protect the fabric or material. Nano-spheres may also be implanted into the synthetic fiber filament walls to waterproof a fabric surface. Nano-particles increase durability and performance. The exterior fabrics or material may be waterproofed with the NANOSPHERE Technology by Schoeller Textile

Nano-technology may optionally waterproof or increase moisture transfer properties in a fabric or nonwoven. Inner lining material or fabric MVT characteristics can be enhanced by NANO-DRY by Burlington Fabrics or NANO-TEX. Nano-Dry technology perforates the synthetic fiber walls with silica particles and allows moisture to move quickly from the fiber surface. Alternatively, nano-technology can chemically developed a molecular sleeve or framework of silicates around the fiber filament and increase the moisture transfer or waterproof performance. Nano-technology may be applied to the molecular structure of a fiber or around the fiber. Additionally, nano-technology can be applied along a fiber in Nano Channels. Nano Channels are created to control the flow of minuscule amounts of fluid. The channels have elliptical edges which permit fluid to flow freely along the fiber enhancing the MVT rates. A transparent substance of silicon, silicon dioxide or glass is heated and applied to the fibers. The nano-technology may be thermally sprayed. Inframat Corporation has developed a patented process for thermal spray of nano-structured, by which the nano-particles can be reconstituted into spherical micron-sized granular particles that can be thermally sprayed. The nano-technology can be thermally sprayed onto any layer in this MVT system and especially to the exterior soft-shell fabric or material layer. The NANOSPHERE technology is self-cleaning and stain resistant. Preferably nano-technology is developed by Burlington Technologies, Toray International, Inframat Corporation, Ardesta, Nanophase Technologies Corporation, Caliper, Nanosys, Cambrios, and Innovalight.

This invention further enhances the elastomeric nonwoven and elastomeric cellular nonwoven to a durable exterior shell waterproof material by adding Teflon®, nano treatments and fibers such as nylon, Kelvar® and Cordura® fiber blends to the nonwoven base. These exterior soft-shell nonwoven materials are breathable, moisture transferable and waterproof and can be treated with UV and soil resistant properties.

The preferable waterproof/breathable, elastomeric nonwoven and elastomeric cellular nonwoven exterior soft-shell material transfers moisture and may optionally include anti-microbial fibers, nano-technology and thermal regulated materials. In one option, the elastomeric nonwoven is waterproofed with an inserted continuous porous web structure invented by Caldwell. The porous web structure may be placed in the middle of the elastomeric nonwoven layer or just underneath the top or back surface. The porous web structure placement determines the level of waterproof performance and breathability of a nonwoven layer. The Caldwell encapsulation waterproof process is described in his patents U.S. Pat. Nos. 5,876,792, 5,004,643 and 5,418,051 and is suggested for all exterior shell materials in this invention. The elastomeric nonwoven is optionally waterproofed by encapsulating the fibers by Toray International. Toray International encapsulates fibers with silicone or polymer material. The encapsulated and coated fibers or threads are then combined into a nonwoven layer fused foam polymer or resin to develop the waterproof elastomeric nonwoven or nonwoven cellular in this invention. The elastomeric nonwoven layer may include antimicrobial silver fibers or treatments. Phase Change materials, fibers or a nonwoven layer or film containing Phase Change Technology may be added to the elastomeric nonwoven or elastomeric cellular nonwoven.

This invention develops encapsulated or nano-treated elastomeric nonwovens that are breathable, extremely durable and waterproof. Optionally, the elastomeric nonwovens are anti-microbial and thermal regulated with fibers or with Phase Change Technology.

Incorporated by reference is Caldwell U.S. Pat. Nos. 5,004,643 and 5,418,051. The Caldwell encapsulation process and encapsulation by Toray are both excellent waterproofing options and may be combined with nano-technologies.

The suggested exterior shell materials, used layer 10, 20, 30, or 40, are laminated to a breathable membrane, stretch resin, or treated with encapsulation, a waterproof film, adhesive or treatment, a thermal or foam nano-spray, nano-technologies or are woven man-made fabrics structurally knitted or woven to repel water. These structurally woven or knitted fabrics do not require encapsulation, nano-technology or breathable membranes to waterproof the garment. The can be combined with nano technology, Phase Change Technology or ionized treatments. The nano-spray developed with light weight environmentally adhesives and polymers can contain a phase change material. The preferred waterproof fabrics are Microft by Teijin Shojin, Gymstar Plus and Tuflex-HR, both by Unitika, Ltd. Another preferable fabric is a structurally knitted acrylic or acrylic blends, which may be encapsulated and distributed by ASF and made by Toray, for example. A number of marketed waterproof exterior films and treatment could be added as an option for snowboard apparel, especially for areas covering an individual's knees, elbows, and buttocks area. These films (DWRs) are applied by fabric manufacturers themselves. This film may or may not be used with encapsulation but may be used in combination with the waterproof breathable membrane systems. High abrasive materials, preferably Kevlar® Fabrics by Schoeller, may also be added along areas of pants, elbows, pocket lines, cuffs, and buttock areas.

All technical apparel will preferably have seams hot melted or adhesively sealed to prevent moisture from entering along stitching lines. The extreme apparel will add zipped underarm vents to aid in moisture release and will contain a hydrophilic open-cell foam collar band and wristband covers by inner fabric selection to absorb excess moisture and transport it away from the individual. A rain gut along the front shirt zipper line may be added to aid in moisture transfer.

Examples 2-6 illustrate various applications of the present invention as contemplated by the inventor. These applications are discussed, by way of example only. More specifically, examples 2-6 illustrate various styles of shirts/jackets incorporating the present invention in different combinations. These all-in-one moisture transfer composite systems of waterproof technical apparel create the entire layered system of the jacket. The examples represent different types of apparel constructed from the following composite materials. It is once again mentioned that Phase Change and nano-technology can be combined with the materials or composites listed below, although not specifically mentioned. In other words, Phase Change Technologies or nano-technology microsphere technology can be combined with the foam materials, films, stretch resins, breathable membranes, THERMOLITE, or a nonwoven layer, or any of the outer shell materials or fabrics. Outlast/Phase Change Technologies (PCM) can also be combined with encapsulation by Nextec, Toray or the like or nano-technology for use in the outer layer 40.

Nano-technology or Teflon® treatments and Phase Change Technology can be combined for thermal regulation and waterproofing. Nano-Tex/nano-technology and Phase Change Technology may be further combined for moisture transfer properties and waterproof in the outer shell layer. Nano-technology and Nano-tex by Burlington, Toray, Schoeller or the like may be applied to any layer in this invention to increase moisture transfer performance. Of course, Outlast or Phase Change Technologies can also be used by itself.

This invention develops elastomeric nonwovens in a single layer construction or elastomeric composite nonwovens in a multi-layer construction with one or more options such as breathable, open-cell foam material, polymer stretch resin, polymer web matrix, or a pre-made breathable, moisture transfer nonwoven layer. The nonwoven layer may be an aperture nonwoven, a high loft spun bond nonwoven or the like, or a air-laid, dry-laid or polymer-laid product.

The following examples are disclose preferable combinations for the technical composite apparel use MVT moisture vapor transfer composites and waterproof soft shell materials.

Example 1 is preferably formed by a layer 40 formed from a cotton blend fabric that is encapsulated and may include denim and chino fabrics. Inside of layer 40 is a layer 20 which is a cellular elastomeric composite of an open-cell breathable, hydrophilic 1/16″ to ¼ foam having a moisture absorbent and transfer nonwoven top sheet. Inside of layer 20 is a layer 10 of any of the inner liner materials listed above in connection with layer 10. According to this application, layer 30 is omitted.

Example Two has a layer 40 of a natural fiber such as cotton or wool or a blend encapsulated abutting layer 20, a THERMOLITE Extreme, THINSULITE, Microloft, MVT Thermal or the like, with or without Phase Change Technologies and/or hydrophilic open-cell foam. The nonwoven THERMOLITE may be mechanically combined with a breathable, open-cell foam or breathable, open-cell foam and absorbent and moisture transfer nonwoven. THERMOLITE or THINSULITE can be combined with the MVT Thermal composite described in this invention for increasing moisture transfer and thermal properties. The preferably open-cell foam is AQUAZONE or VPF developed by Foamex. Inside layer 20 is layer 10 which can be any of the inner liner materials mentioned above in connection with layer 10. Layer 30 is omitted.

Example Three has a layer 40 that is a wool/cotton/acrylic/polyester blend or an elastomeric nonwoven. Inside layer 40 is a layer 30 which is a waterproof breathable membrane adhesive or film. Inside layer 30 is a layer 10 which is one of various inner liner materials. Layer 20 is omitted. Phase Change and/or nano-technology can be added to any layer in this apparel item.

Example Four is a layer 40 that is a wool/cotton/acrylic/polyester blend or an breathable moisture transfer elastomeric nonwoven. Inside layer 40 is layer 30 which is a waterproof breathable membrane. Inside layer 30 is a layer 20 which is either MVT Thermal, THERMOLITE or reticulated/open-cell hydrophilic foam with or without Phase Change Technology. If breathable, open-cell foam is used, AQUAZONE or VPF is preferred. Also, the MVT THERMAL, THERMOLITE and foam may be combined. Inside layer 20 is layer 20 of one of the inner liner materials. Phase Change and/or nano-technology can be added to any layer in this apparel item.

Example Five is a layer 20 of a nylon or nylon blend such as stretch Cordora® by IBQ or Schoeller, an breathable, moisture transfer elastomeric nonwoven, 2/4 Supplex, 6-ply Taslan, Cordura®, Micro-Technical II and III, Citation Sanded, Tudor, Mojave, Twister Travis Fabrics, Kevlar® Fabrics, laminated to a breathable membrane or encapsulated outer fabrics. Inside of layer 40 is a layer 30 of THERMOLITE, THINSULITE or a MVT Thermal composite. Instead of THERMOLITE, a reticulated/open-cell hydrophilic foam may be used, or may be combined with the THERMOLITE, THINSULITE and an open-cell, breathable foam or a MVT THERMAL and THERMOLITE or THINSULITE. Inside layer 30 is a layer 20 of a cellular elastomeric composite. Inside layer of 20 is a layer 10 of one of the inner liner materials. Phase Change Material (PCM) and or nano-technology can be added to any layer in this apparel item.

Example Six is a layer 40 of Gymstar Plus or Microft Super structural constructed water-repellent fabrics or an elastomeric nonwoven. Inside layer of 40 is a layer 20 of a nonwoven and foam composite with or without a breathable membrane 30 between layers 40 and 20. Inside layer of 20 is a layer 10 of one of the inner liner materials. Phase Change Material (PCM) and/or nano-technology can be added to any layer in this apparel item.

Example Seven is a layer 40 of Gymstar Plus, Super Microft, Tuflex-HR, abutting a THINSULITE or THERMOLITE Extreme, MVT THERMAL, hydrophilic, breathable, open-cell foam or a combination a nonwoven and foam or THINSULITE or THERMOLITE with a foam and or nonwoven blend. Inside of this layer 40 is a layer 20 which is a breathable, moisture transfer, cellular elastomeric composite or an elastine nonwoven manufactured by Freudenberg or a breathable, open-cell, foam with a moisture transfer, breathable, absorbent nonwoven composite laminated to a top sheet laminated thereto. A breathable membrane 30 can optionally be added between layers 20 and 40.

Example Eight has a layer 40 made of one of the possible fabrics mentioned above, except Gymstar Plus or Super-Microft waterproof breathable membrane or technology. Inside of layer 40 is a layer 20 which is a breathable, moisture transfer, cellular elastomeric composite. Inside of layer 20 is a layer 10 of one of the inner liner materials. Phase Change Technology and/or nano-technology can be added to any layer in this apparel item.

Example Nine has a layer 40 made of one of the possible fabrics mentioned above, except Gymstar Plus or Super-Microft, treated with a waterproof technology. Inside layer 40 is a layer 30 a layer of THERMOLITE or a MVT THERMAL. Layer 20 is an open-cell, breathable, reticulated or hydrophilic open-cell foam with a nonwoven top sheet. Inside of layer 30 or layer 20 is a layer 10 of one of the inner liner materials. Phase Change and/or nano-technology can be added to any layer in this apparel item.

Example Ten is a layer of MVT inner lining material or fabric backed by MVT thermal flocked fiber blend abutting an exterior shell fabric or material. The MVT thermal flock is attached to a stretch resin or elastomeric nonwoven composite in between the inner lining material and outer shell material. The exterior shell fabric or material is optionally waterproofed by encapsulation, Telfon®, nano-technology membrane, film, internal web, matrix, nano-spray or coating.

Example Eleven is a MVT inner lining material abutting a MVT THERMAL composite or CHAMELEON composite and exterior shell fabric or material. The exterior shell fabric or material is optionally waterproofed by encapsulation, nano-technology, membrane, film, internal web, matrix, Teflon or the like, silicone or a nano-spray or coating.

Example Twelve is a MVT fabric or material abutting elastomeric nonwoven composite and a MVT THERMAL or CHAMELEON composite and exterior shell fabric or material. The exterior shell fabric or material is optionally waterproofed by encapsulation, nano-technologies, membrane, film, internal web, matrix or coating.

Example Thirteen is a MVT fabric or material backed by a stretch resin and a moisture transfer, thermal flocked fiber blend and is a single performance layer apparel product.

Example Fourteen is an exterior shell MVT fabric or material backed by a stretch resin, open-cell foam layer or adhesive and a moisture transfer, thermal flocked fiber blend and is a single performance layer apparel product. This single layer exterior shell material or fabric may be waterproof. The flocked fiber blend may completely cover the fabric surface or be applied in a dot matrix.

Example Fifteen is MVT THERMAL composite first layer 10 and an exterior shell fabric or elastomeric nonwoven or an elastomeric nonwoven composite.

Example Sixteen is a MVT fabric, material or elastomeric nonwoven or elastomeric nonwoven composite in layer 10 abutting a MVT Thermal, CHAMELEON nonwoven composite or a Freudenberg Phase Change nonwoven and an exterior shell mesh, elastomeric nonwoven or fabric. The exterior shell may be waterproofed.

Example Seventeen is a MVT fabric or material abutting a spacer fabric and exterior shell fabric. This exterior shell fabric may be waterproofed in some options.

Example Eighteen is a MVT fabric or material abutting a spacer fabric, a foam and exterior shell fabric. This exterior shell fabric may be waterproofed in some options.

Example Nineteen is a MVT fabric or material abutting a cellular elastomeric composite, a spacer fabric, foam and exterior shell fabric. This exterior shell fabric may be waterproofed in some options.

Example Twenty has a MVT fabric or material abutting a MVT THERMAL composite or Freudenberg nonwoven or Schoeller PCM nonwoven, spacer fabric and exterior shell fabric. This exterior shell fabric may be waterproofed in some options.

Example Twenty-One has a MVT fabric or material abutting a foam, MVT THERMAL or Freudenberg nonwoven and/or composite, spacer fabric and exterior shell fabric. This exterior shell fabric may be waterproofed in some options.

Example Twenty-Two has a MVT fabric or material abutting a foam, MVT THERMAL or Freudenberg or Schoeller PCM nonwoven, spacer fabric, foam and exterior shell fabric. This exterior shell fabric may be waterproofed in some options.

Example Twenty-Three has an inner moisture transfer fabric or material abutting a nonwoven fibrous layer with polyester fibers. The nonwoven having a foamed or adhesive dotted surface pattern containing Phase Change or nano-technology or a combination and a outer shell material treated to have waterproof properties.

Example Twenty-Four is a waterproof shell material backed by a blend of flocked fiber in a solid layer or patterned surface containing shaped, hollow, grooved fibers and silver anti-microbial fibers. A composite fabric that is warm and anti-microbial for rain gear and the like.

The examples presented above are various composite combinations presented in this invention. The technical composites can be realized on different parts in different types of apparel or as the entire garment. Other variations are also possible given the range of combinations that are possible in this invention.

It may be noted in this invention that there are no stated specified rates of breathability or moisture transfer. The selected products and performance category in the product line determine the selected breathable and moisture transfer rates. The MVT and breathable rates are developed by the selected fibers, foams and materials for these technical composites product systems and are determined by the performance level and product company.

The microfiber technology disclosed above is rapidly developing and changing and has greatly increased the potential for improved performance of products such as performance apparel, provided that they are properly utilized as in the present invention. These new products are part of rapidly developing technical textile technology. The present invention employs a combination of fabrics, foam layers, nonwovens, spacer fabrics, breathable membranes, encapsulated technology, structurally woven water repellent fabrics, or waterproof film coatings in such combinations that increase the performance of the products in which they are used as well as increase the breathability. There are many new membranes on the market to select from with excellent breathable and moisture transfer properties. The invention further discloses a waterproof breathable, MVT Thermal end-use performance garment as site in the above examples and additional composite combinations. The MVT Thermal may be treated with nano-technology, encapsulation or waterproof treatments.

The invention further discloses a waterproof breathable, moisture transfer spacer fabrics end-use performance garment. The MVT Thermal may be treated with nano-technology, encapsulation or waterproof treatment.

Spacer fabric garment is developed in several unique ways. In one option, the first layer of the spacer fabric is a inner moisture transfer nonwoven layer close to the body and the first layer of the garment. The nonwoven layer is attached to the fibrous material in the middle comprised of nonwoven shaped, grooved and hollow filaments and a knitted construction in this third layer. The nonwoven in the first layer may also replace the knitted third layer. The nonwoven layer may be coated with a Phase Change material and/or nano-technology and contain silver anti-microbial fibers. The breathable, flexible spacer products may comprise a portion or the entire garment and may be treated with waterproof treatments. Optionally, these light weight breathable space composites or garments may include fibers treated with encapsulation or nano-technology. Both natural and synthetic fibers may be included in the spacer products. Wool, cotton, lyocel, elastine, acetate, acrylic and others may be added to the fiber blends.

The invention further discloses a waterproof breathable, moisture transfer, waterproof elastomeric, nonwoven treated with nano-technology and/or soil retardant treatments for use in a technical end-use performance shell garments or technical composite apparel.

FIG. 1 represents composite combinations of technical, elastomeric, moisture transfer composites systems or single layer inner lining (10)and soft shell materials or fabrics (40) combined with layer (20) and layer (30) comprised of multi-layered foam and nonwoven thermal composite systems waterproofed with nano-technology, membranes, films (DWR)'s encapsulation or the like.

FIG. 2 represents a technical garment with an exterior shell waterproof, stretchable, soft shell materials or fabric (400) backed by a moisture transfer nonwoven (300) treated with a foamed dotted pattern containing Phase Change Technology or nano-technology (200).

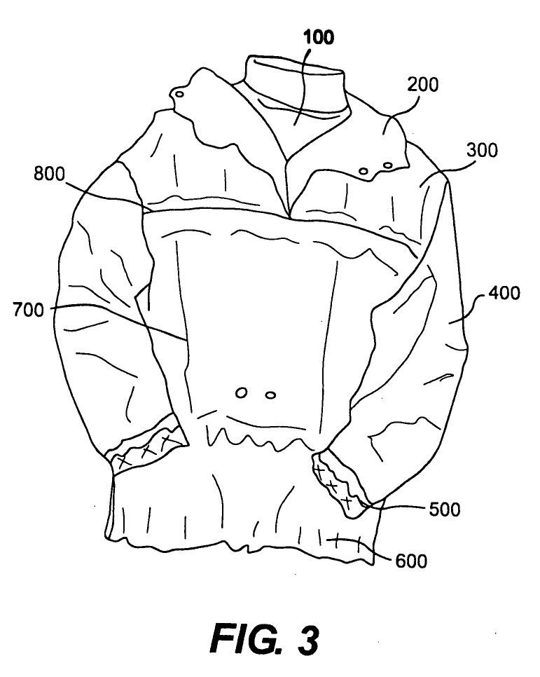

FIG. 3 represents a technical alpine garment with multiple layered options disclosed in examples one through twenty-three. This garment may combine a number of options in the inner lining fabric or materials (200), sleeves (400) and back and front panels (700) and neck (100)and sleeve (400) and waist (600) and (500) cuff areas. The selected composites and construction depends on the performance criteria.

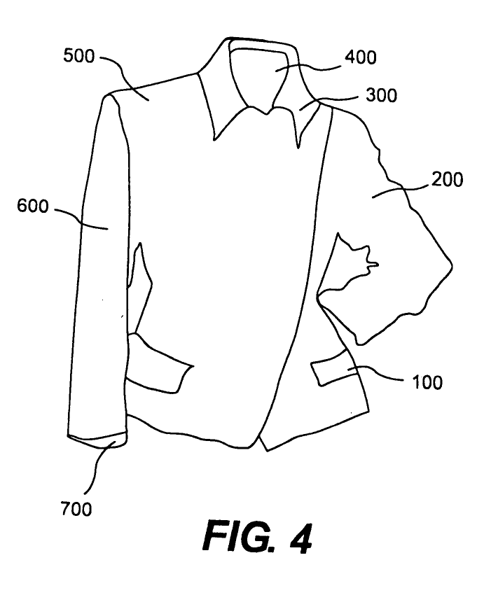

In FIG. 4 this Casual Tech garment can be comprised of a selected soft shell material (500), but is preferably a waterproof, stretch cotton, polyester or nylon fabric or a blend containing nano-technology (600). The face fabric of the garment is backed by a moisture transfer nonwoven (400) by Baychar textiles and inner lining material (700) by coville or Deercreek fabrics or the like. The sleeves (200) can optionally contain an elastomeric composite and the pocket (100) can be seam welded with adhesives.

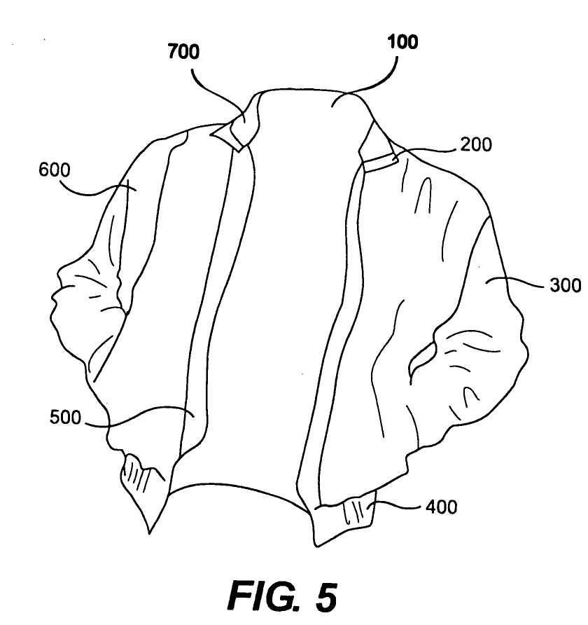

In FIG. 5 this Casual Tech garment is an example of an the inner moisture transfer materials (100) and an outer soft shell fabric selected from the IBQ, Toray or Schoeller stretch cordura or brushed nylon blends (600 and 300) treated with waterproof and soil resistant technology. The inner moisture transfer fabric (100) is backed by and elastomeric foam and nonwoven composites (500). The collar 700 and (200) are comprised of a moisture transfer brushed fabric or nonwoven and waterproof nano-technology. The waist (400) is a stretchable moisture transfer waistband with an inner moisture transfer fabric and outer shell fabric as disclosed in layer (600).

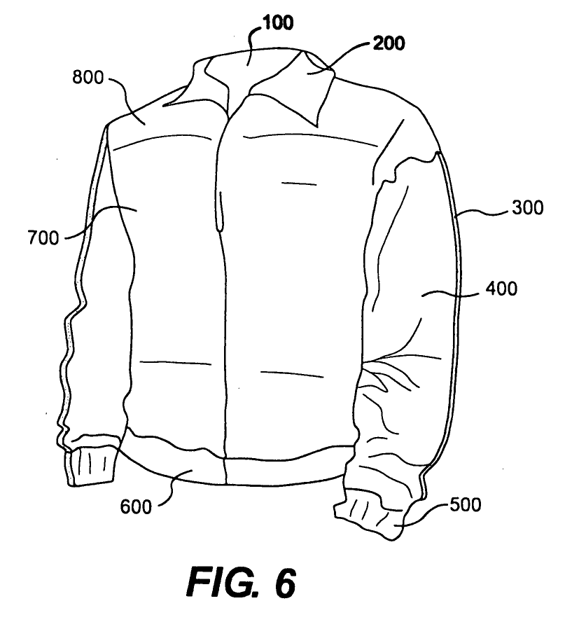

FIG. 6 is a lightweight breathable Casual Tech shirt comprised of a exterior soft shell material preferably waterproof cotton or nylon zip-up shirt with an moisture transfer nonwoven and foam composite layer (300) and an inner moisture transfer elastomeric fabric (100). The collar (200) is comprised of a lightweight breathable moisture transfer stretchable elastine material. The shoulders are a durable corduroy or a brushed fleece or wool (800). The front and back panels (700) are stretchable cotton or nylon blends and the cuffs (500) and waist band (500) are a durable Kelvar® or Cordura® stretch fabric. Optionally, a flocked layer can replace the inner moisture transfer fabric or be combined with another layer for added warmth. The seamless seam technology is applied to the pocket and garment seams of sample garments. The inner moisture transfer nonwovens layers may have a dotted phase change material on the nonwoven surface in layer in these examples and others as constructed by examples and the invention combinations.

While the present invention has been described above in connection with the preferred embodiments, one of ordinary skill in the art would be enabled by this disclosure to make various modifications to the disclosed embodiments and still be within the scope and spirit of the present invention as recited in the appended claims.

What is claimed:

1. A moisture transfer, absorbent, stretchable, nonwoven composite for apparel comprised of a layer of synthetic, shaped and grooved fibers, silver and natural fibers mechanically bonded to a second moisture transferring nonwoven layer comprised of synthetic fibers and an open-cell, breathable, moisture transfer, anti-microbial foam layer or material.

2. A technical apparel composite according to claim 1, wherein the second nonwoven layer has polyester hollow fibers bonded with an acrylic resin.

3. A technical apparel composite according to claim 1, wherein the mechanically bonded nonwoven composite is attached on the other side to an exterior, soft shell elastomeric fabric or material.

4. A technical apparel composite according to claim 1, wherein the soft shell material is an elastomeric cellular composite.

5. A technical apparel composite according to claim 1, wherein the elastomeric fabric is a stretch woven or nonwoven.

6. A technical apparel composite according to claim 1, wherein the nonwoven layer contains phase change materials.

7. A technical apparel composite according to claim 1, wherein the nonwoven layer contains nano-technology.

8. A technical apparel composite according to claim 3, wherein the nonwoven composite apparel is waterproofed with nano-technology.

9. A moisture transfer, absorbent, stretchable, spacer fabric composite material for technical apparel comprised a bed of a fibrous, moisture transferring, absorbent nonwoven material sandwiched between two breathable, moisture transferring, absorbent, anti-microbial elastomeric nonwoven layers.

10. A technical apparel composite according to claim 9, wherein the fibrous nonwoven bed contains shaped and grooved fibers.

11. A technical apparel composite according to claim 10, wherein the fibrous nonwoven bed contains silver fibers.

12. A technical apparel composite according to claim 10, wherein the fibrous nonwoven bed contains Phase Change Technology.

13. The moisture transfer apparel worn by an individual comprising, on at least a portion of the apparel, a combination of layers constructed as follows:
a first layer, closest to the individual, selected from a group of inner moisture transfer, breathable, absorbent, materials or fabrics,
a second layer, abutting the first layer, including a combination of moisture transfer, absorbent, breathable, anti-microbial, stretchable nonwoven composite comprised of a natural and synthetic fiber blend of grooved, shaped and anti-microbial silver fibers mechanically bonded to form a moisture transfer, absorbent nonwoven composite layer,
a third layer, abutting the second layer, selected from the group of moisture transfer, breathable outer soft-shell materials.

14. A moisture transfer apparel according to claim 13, wherein the moisture transfer, anti-microbial, absorbent, stretchable nonwoven composite layer is mechanically bonded to an open-cell breathable, anti-microbial foam material.

15. A moisture transfer apparel according to claim 13, wherein the moisture transfer absorbent, stretchable composite nonwoven layer contains synthetic hollow and/or split fibers.

16. A moisture transfer apparel according to claim 13, wherein at least one or more layers of the moisture transfer composite apparel contains are treated with Phase Change Technology.

17. A moisture transfer apparel according to claim 13, wherein at least one layer or more layers of the moisture transfer composite apparel contain or are treated with nano-technology.

18. A moisture transfer apparel according to claim 15, wherein the outer shell material is waterproofed by encapsulation, nano-technologies, spray, film or coating.

19. A moisture transfer, technical composite apparel or portion of the apparel to be worn by an individual constructed the following layers:
a first layer, selected from a group of moisture transfer, waterproof, breathable outer soft-shell materials or fabrics;
a second layer, abutting the first layer, comprised of a moisture transfer, breathable, stretch, elastomeric cellular nonwoven composite made in one process; and
a third layer backing the breathable, stretch elastomeric nonwoven cellular composite comprised of a flocked fiber blend containing two or more hollow, shaped, grooved or split synthetic fibers, silver fibers, natural absorbent and thermal fibers.

20. The moisture transfer technical apparel according to claim 19, wherein the waterproof, breathable outer soft-shell layer is attached to the second layer comprised of a stretch elastomeric nonwoven composite formed in one process containing a breathable, flexible, open-cell foam material and moisture transfer, absorbent, synthetic shaped, grooved or hollow fibers, natural fibers and anti-microbial properties
